(19) United States
(12) Patent Application Publication
(10) Pub. No.: US 2022/0147758 A1
(43) Pub. Date: May 12, 2022

(54) COMPUTER-READABLE RECORDING MEDIUM STORING INFERENCE PROGRAM AND METHOD OF INFERRING

(71) Applicant: FUJITSU LIMITED, Kawasaki-shi (JP)

(72) Inventor: Masayuki HIROMOTO, Kawasaki (JP)

(73) Assignee: FUJITSU LIMITED, Kawasaki-shi (JP)

(21) Appl. No.: 17/401,353

(22) Filed: Aug. 13, 2021

(30) Foreign Application Priority Data
Nov. 10, 2020 (JP) 2020-187621

(51) Int. Cl. G06K 9/62; G06K 9/46; G10L 25/30; G06F 40/20; G10L 25/03; G06N 5/04; G06N 3/08

(52) U.S. Cl. CPC G06K 9/629; G06K 9/46; G10L 25/30; G06K 9/6256; G10L 25/03; G06N 5/04; G06N 3/08; G06F 40/20

(57) ABSTRACT

A non-transitory computer-readable recording medium storing an inference program for causing a computer to execute a process, the process including: extracting features of a piece of data by inputting the piece of data to a neural network; generating a hyperdimensional vector based on the extracted features; and storing the generated hyperdimensional vector in a storage unit with the hyperdimensional vector related to a label of the piece of data.

### CROSS-REFERENCE TO RELATED APPLICATION

This application is based upon and claims the benefit of priority of the prior Japanese Patent Application No. 2020-187621, filed on Nov. 10, 2020, the entire contents of which are incorporated herein by reference.

### FIELD

The embodiment discussed herein is related to a computer-readable recording medium storing an inference program and a method of inferring.

### BACKGROUND

Today, neural networks (NNs) are actively used in image recognition and other fields. For example, the accuracy of image recognition is significantly improved by using deep learning (DL).

As the related art, for example, there is a technique for face recognition in which a neural network is used transforming images of faces into a high-dimensional vector and the distance of the high-dimensional vectors from new faces are compared to a set of reference vectors of trained faces.

Also, as the related art, there is hyperdimensional computing (HDC) that is one of non-von Neumann computing techniques focusing on information expression in the brain.

Examples of the related art include as follows: Japanese Laid-open Patent Publication No. 2019-165431.

Examples of the related art also include as follows: Kanerva, P, “Hyperdimensional Computing: An Introduction to Computing in Distributed Representation with High-Dimensional Random Vectors”, Cognitive Computation, vol. 1, no. 2, pp. 139-159, 2009.

Since knowledge obtained by learning is included in the NN, there is a problem with the NN in that the obtained knowledge is unclear. In today's computing, an analysis and inference using the DL are possible. However, in order to realize intelligent computing closer to human intelligence, it is important to utilize the knowledge, and clarification and storing of the knowledge obtained by the NN are premises for the utilization of the knowledge.

In one aspect, an object of the present embodiment is to clarify and store knowledge obtained by an NN.

### SUMMARY

According to an aspect of the embodiments, there is provided a non-transitory computer-readable recording medium storing an inference program for causing a computer to execute a process. In an example, the process includes: extracting one or more features of a piece of data by inputting the piece of data to a neural network; generating a hyperdimensional vector based on the extracted one or more features; and storing the generated hyperdimensional vector in a storage unit with the hyperdimensional vector related to a label of the piece of data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining inference performed by an inference apparatus according to an embodiment;

FIGS. 2A and 2B illustrate a diagram for explaining an HV;

FIG. 3 illustrates a representation example of a set obtained by addition;

FIG. 4 is a diagram for explaining learning and inference in HDC;

FIG. 5 is a diagram for explaining multimodal capability of the inference apparatus according to the embodiment;

FIG. 6 is a diagram for explaining the multimodal capability of the inference apparatus according to the embodiment using attributes HVs;

FIG. 7 illustrates an example of the multimodal capability of the inference apparatus according to the embodiment;

FIG. 8 illustrates a functional configuration of the inference apparatus according to the embodiment;

FIG. 9A illustrates short-term learning;

FIG. 9B illustrates middle-term learning;

FIG. 9C illustrates long-term learning;

FIG. 10 is a flowchart illustrating a flow of processing in a learning phase performed by the inference apparatus;

FIG. 11 is a flowchart illustrating a flow of processing in an inference phase performed by the inference apparatus;

FIG. 12 illustrates an observe-orient-decide-act (OODA) loop for realizing intelligent computing; and

FIG. 13 illustrates a hardware configuration of a computer that executes an inference program according to the embodiment.

### DESCRIPTION OF EMBODIMENTS

In an aspect of the embodiments disclosed below, there is provided a solution to clarify and store the knowledge obtained by the NN.

Hereinafter, an embodiment of an inference program and a method of inferring disclosed in the present application is described in detail with reference to the drawings. The embodiment does not limit the disclosed techniques.

### Embodiment

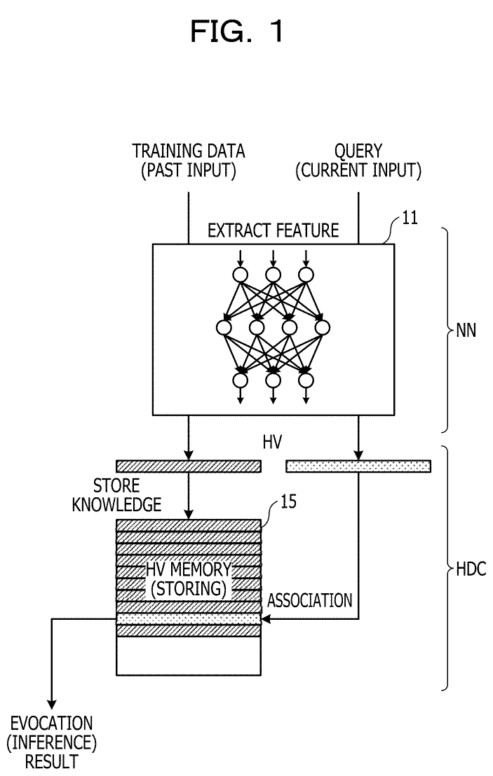

First, inference performed by an inference apparatus according to the embodiment will be described. FIG. 1 is a diagram for explaining inference performed by the inference apparatus according to the embodiment. As illustrated in FIG. 1, the inference apparatus according to the embodiment extracts a feature(s) of training data by inputting the training data to a neural network (NN 11) in a learning phase. Then, the inference apparatus according to the embodiment generates a hyperdimensional vector (HV) based on the extracted feature(s) and stores the generated HV as knowledge in an HV memory 15 with the generated HV related to a label of the training data. The HV memory 15 is a content addressable memory (CAM) and evokes the label from the HV. It is noted that the feature of training data may be referred to as a feature quantity, a feature amount, and the like.

In an inference phase, the inference apparatus according to the embodiment extracts a feature(s) of a query by inputting the query to the NN 11. The inference apparatus according to the embodiment generates an HV based on the extracted feature(s), identifies a label evoked from the generated HV by using the HV memory 15, and outputs the identified label as an inference result.

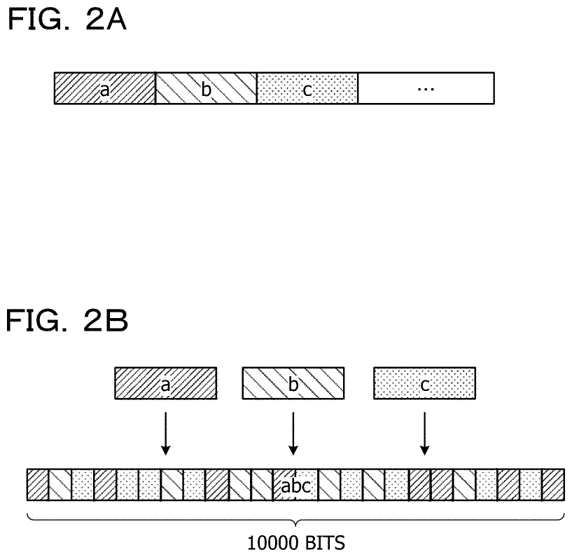

FIG. 2 (i.e., FIGS. 2A and 2B) is a diagram for explaining the HV. The HV is a data representation used in a hyperdimensional computing (HDC). In the HV, data is represented in a distributed manner by a hyperdimensional vector of 10000 or larger dimensions. In the HV, various types of data are represented by vectors having the same bit length.

As illustrated in FIG. 2A, in a normal data representation, pieces of data such as a, b, c are collectively represented on a piece-by-piece basis. In contrast, as illustrated in FIG. 2B, in a hyperdimensional vector, pieces of data such as a, b, c are represented in a distributed manner. In the HDC, data is able to be manipulated by simple operation such as addition and multiplication. Also in the HDC, relationships between pieces of data are able to be represented in addition or multiplication.

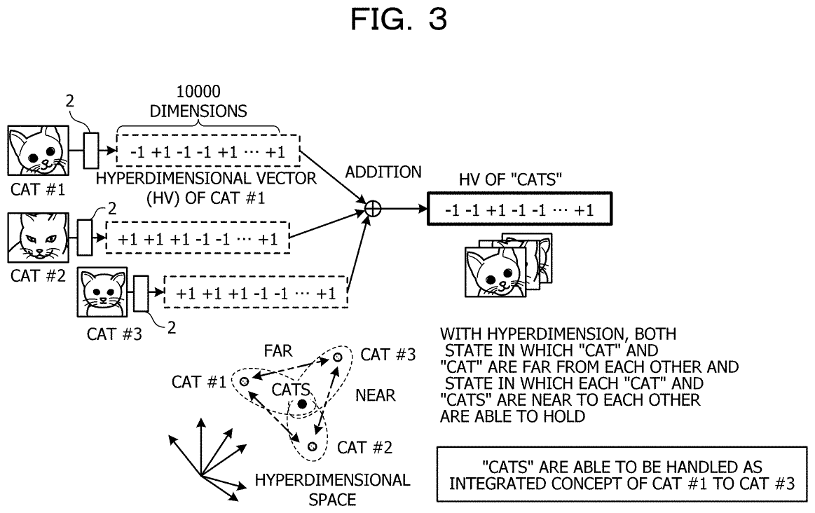

FIG. 3 illustrates a representation example of a set obtained by addition. In FIG. 3, HV encoders 2 generate the HV of a cat #1, the HV of a cat #2, and the HV of a cat #3 respectively from an image of the cat #1, an image of the cat #2, and an image of the cat #3. Individual elements of the HV are “+1” or “−1”. The cats #1 to 3 are each represented by the HV of 10000 dimensions.

As illustrated in FIG. 3, an HV obtained by adding the HVs of the cat #1, the cat #2, and the cat #3 represents a set including the cat #1, the cat #2, and the cat #3, for example, “cats”. The addition of the HVs is addition performed on an element-by-element basis. When an addition result is positive, the addition result is substituted with “+1”. When the addition result is negative, the addition result is substituted with “−1”. When the addition result is “0”, the addition result is substituted with “+1” or “−1” under a predetermined rule. In the HDC, both a state in which a “cat” and a “cat” are far from each other and a state in which each “cat” and “cats” are near to each other are able to hold. In the HDC, the “cats” are able to be handled as an integrated concept of cat #1 to cat #3.

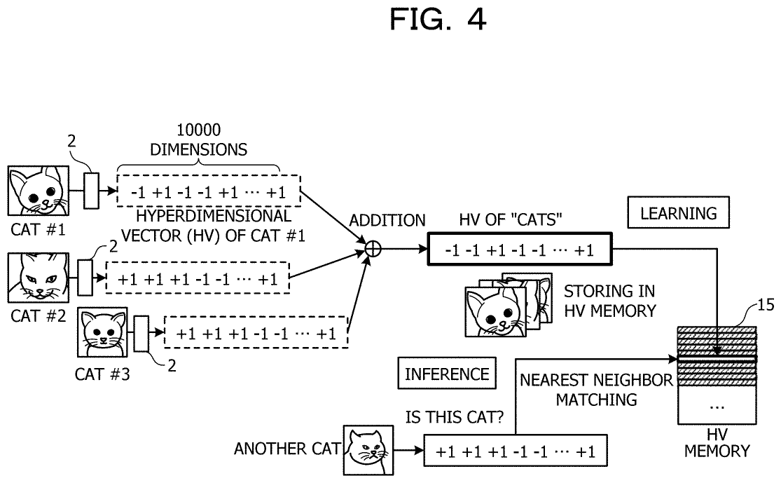

FIG. 4 is a diagram for explaining learning and inference in the HDC. As illustrated in FIG. 4, in the learning phase, the HV encoders 2 generate the HV of the cat #1, the HV of the cat #2, and the HV of the cat #3 respectively from the image of the cat #1, the image of the cat #2, and the image of the cat #3. The HV of the cat #1, the HV of the cat #2, and the HV of the cat #3 are added to generate the HV of the “cats”, and the generated HV is stored in the HV memory 15 with the generated HV related to the “cats”.

In the inference phase, an HV is generated from an image of another cat, the HV of the “cats” is retrieved from the HV memory 15 as an HV that matches the generated HV through nearest neighbor matching, and a “cat” is output as the inference result. Here, the nearest neighbor matching is to calculate the degree of matching between HVs by using the dot product between the HVs and output a label with the highest degree of matching. When two HVs are Hᵢ, Hⱼ, a dot product p=Hᵢ·Hⱼ is D (the dimension of the HVs) in the case where Hᵢ and Hⱼ match, and −D in the case where Hᵢ and Hⱼ are orthogonal to each other. Since the HV memory 15 is a content addressable memory, the nearest neighbor matching is performed at high speed.

In FIG. 1, the HV is generated based on the feature(s) extracted by the NN 11 instead of the HV encoders 2. In FIG. 1, extracting the feature(s) from the image, which is patternlike processing, is performed by the NN 11, and storing the HV in the HV memory 15 and association by using the HV memory 15, which are symbolic processing, is performed by the HDC. In this way, when the advantageous characteristics of the NN 11 and the HDC are utilized, the inference apparatus according to the embodiment may efficiently perform learning and inference.

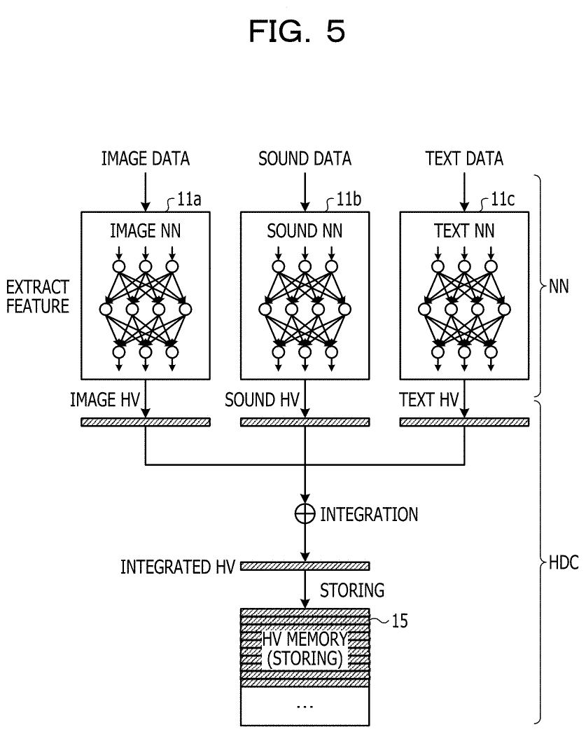

Although FIG. 4 illustrates the case where a single type of data is handled, the inference apparatus according to the embodiment is able to handle a plurality of types of data. For example, the inference apparatus according to the embodiment has multimodal capability. FIG. 5 is a diagram for explaining multimodal capability of the inference apparatus according to the embodiment. In FIG. 5, the inference apparatus according to the embodiment handles image data, sound data, and text data.

As illustrated in FIG. 5, the inference apparatus according to the embodiment extracts an image feature(s) from image data by using an image NN 11a, a sound feature(s) from sound data by using a sound NN 11b, and a text feature(s) from text data by using a text NN 11c. The inference apparatus according to the embodiment generates an image HV, a sound HV, and a text HV respectively based on the image feature(s), the sound feature(s), and the text feature(s). The inference apparatus according to the embodiment adds the image HV, the sound HV, and the text HV to integrate these HVs, and stores the integrated HV in the HV memory 15.

In this way, the inference apparatus according to the embodiment may easily integrate a plurality of types of knowledge by performing addition in the HDC. Although FIG. 5 illustrates the case where three types of data are handled, the inference apparatus according to the embodiment may handle more types of data.

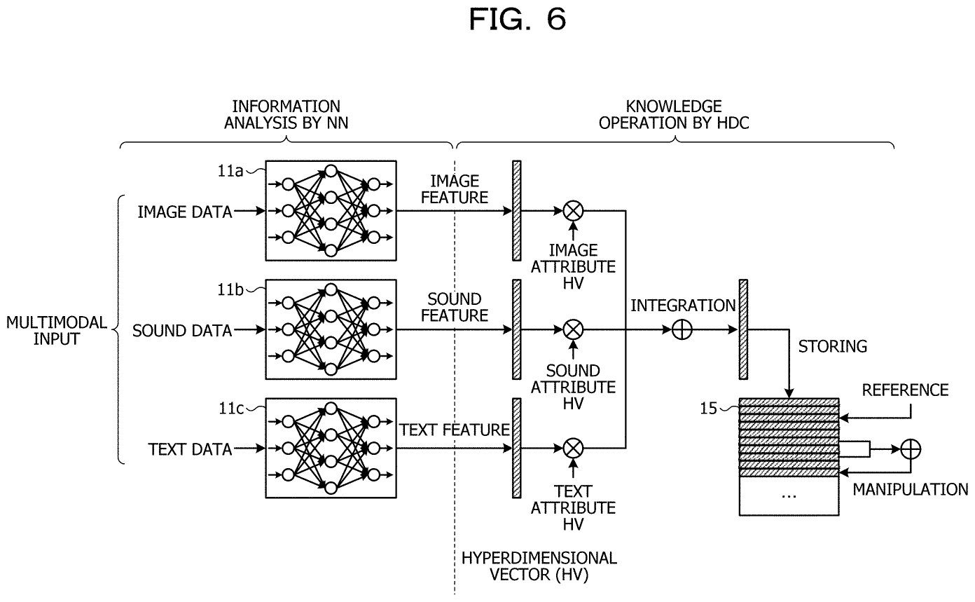

Although the image HV, the sound HV, and the text HV are added to be integrated in FIG. 5, the inference apparatus according to the embodiment may multiply the image HV, the sound HV, and the text HV by an image attribute HV, a sound attribute HV, and a text attribute HV, respectively, and add the results. The multiplication of the HVs is multiplication performed on an HV-element-by-HV-element basis. The dimensions of the image attribute HV, the sound attribute HV, and the text attribute HV are the same as the dimensions of the image HV, the sound HV, and the text HV. FIG. 6 is a diagram for explaining the multimodal capability of the inference apparatus according to the embodiment using the attribute HVs.

As illustrated in FIG. 6, the inference apparatus according to the embodiment performs multiplication between the image HV and the image attribute HV, between the sound HV and the sound attribute HV, and between the text HV and the text attribute HV. The inference apparatus according to the embodiment stores an integrated HV obtained by adding three multiplication results in the HV memory 15.

The inference apparatus according to the embodiment refers to the HV memory 15 in the inference phase. The inference apparatus according to the embodiment manipulates the HV memory 15. For example, the inference apparatus according to the embodiment adds and integrates two similar HVs in the HV memory 15 to integrate two HVs into a single concept.

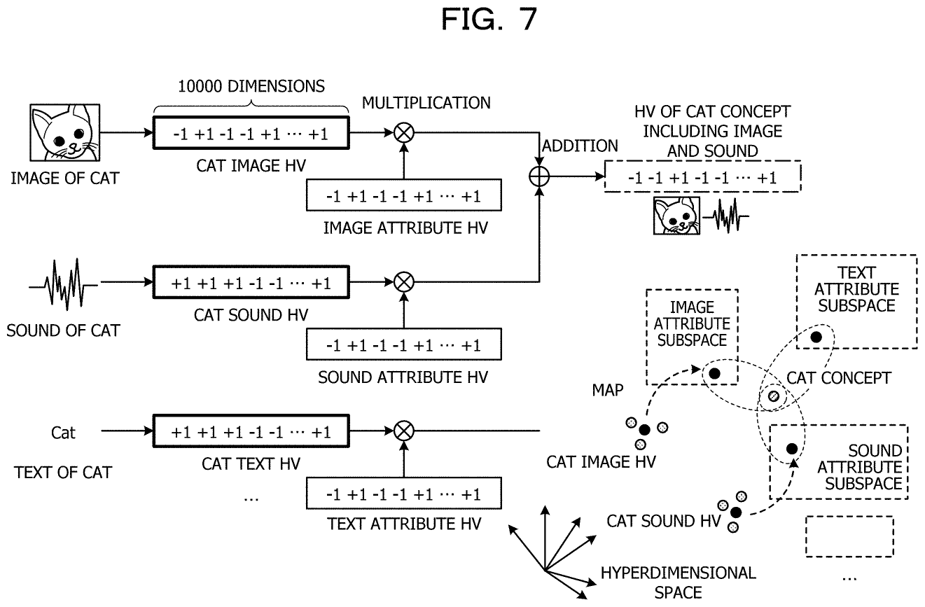

FIG. 7 illustrates an example of the multimodal capability of the inference apparatus according to the embodiment. As illustrated in FIG. 7, the inference apparatus according to the embodiment generates a cat image HV from an image of the cat, a cat sound HV from a sound of the cat, and a cat text HV from a text of the cat. The inference apparatus according to the embodiment multiplies the cat image HV by the image attribute HV, the cat sound HV by the sound attribute HV, and the cat text HV by the text attribute HV. The inference apparatus according to the embodiment is able to generate, for example, an HV of a cat concept including the image and the sound by adding an HV obtained by multiplying the cat image HV by the image attribute HV and an HV obtained by multiplying the cat sound HV by the sound attribute HV.

The operation of multiplying an HV by an attribute HV is to map the HV to a subspace. For example, to multiply the cat image HV by the image attribute HV is to map the cat image HV to an image attribute subspace, and to multiply the cat sound HV by the sound attribute HV is to map the cat sound HV to a sound attribute subspace. When the inference apparatus according to the embodiment multiplies HVs by the attribute HVs to map the HVs to the subspaces as described above, the individual HVs before integration are able to be separated from the other HVs in the integrated HV after integration.

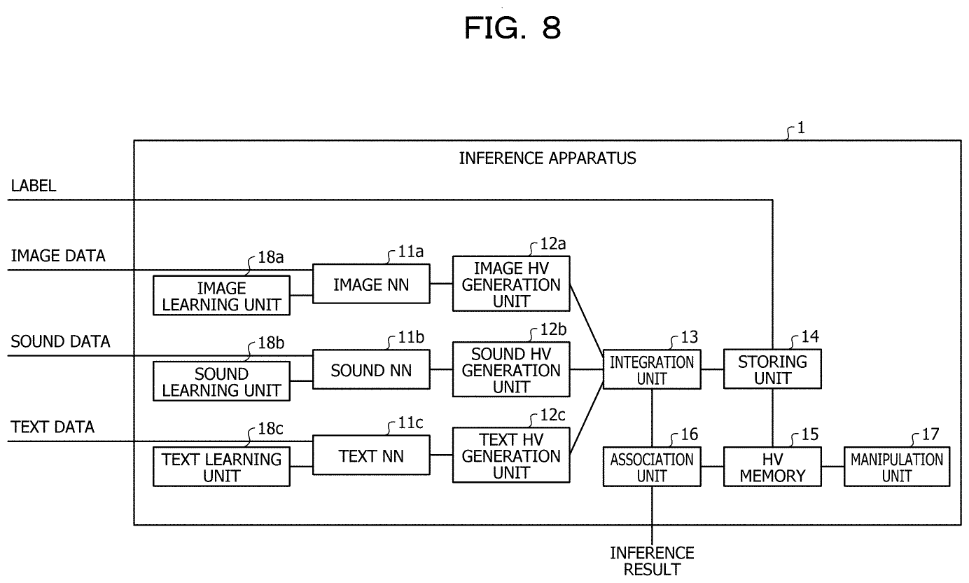

Next, a functional configuration of the inference apparatus according to the embodiment will be described. FIG. 8 illustrates the functional configuration of the inference apparatus according to the embodiment. As illustrated in FIG. 8, an inference apparatus 1 according to the embodiment includes the image NN 11a, the sound NN 11b, the text NN 11c, an image HV generation unit 12a, a sound HV generation unit 12b, a text HV generation unit 12c, an integration unit 13, a storing unit 14, and the HV memory 15. The inference apparatus 1 according to the embodiment further includes an association unit 16, a manipulation unit 17, an image learning unit 18a, a sound learning unit 18b, and a text learning unit 18c.

The image NN 11a receives image data and outputs a feature(s) of the image. The feature(s) of the image is, for example, an output value of a node of an output layer of the image NN 11a. The image NN 11a receives image data of training data in the learning phase and image data of unknown data in the inference phase.

The sound NN 11b receives sound data and outputs a feature(s) of the sound. The feature(s) of the sound is, for example, an output value of a node of an output layer of the sound NN 11b. The sound NN 11b receives sound data of training data in the learning phase and sound data of unknown data in the inference phase.

The text NN 11c receives text data and outputs a feature(s) of the text. The feature(s) of the text is, for example, an output value of a node of an output layer of the text NN 11c. The text NN 11c receives text data of training data in the learning phase and text data of unknown data in the inference phase.

For implementation of the image NN 11a, the sound NN 11b, and the text NN 11c, for example, a graphics processing unit (GPU) and a processor dedicated to deep learning (DL) are used.

The image HV generation unit 12a generates the image HV based on the feature(s) of the image. For example, when the vector of the feature(s) of the image is x and the dimension of x is n, the image HV generation unit 12a centers x. For example, the image HV generation unit 12a calculates an average value vector of x by using expression (1) below and subtracts the average value vector of x from x as represented in expression (2). In expression (1), D_{base} is a set of x, and |D_{base}| is the size of the set of x.

$$\begin{matrix}\overline{x} = \frac{1}{\vert {D}_{base} \vert} {Σ}_{x ∈ Dbase} x & ( 1 ) \\ x ← x - \overline{x} & ( 2 )\end{matrix}$$

The image HV generation unit 12a normalizes x. For example, the image HV generation unit 12a divides x by an L2 norm of x as represented in expression (3) below. The image HV generation unit 12a is not necessarily perform the centering and the normalization.

$$x ← \frac{x}{{‖ x ‖}_{2}} \qquad ( 3 )$$

The image HV generation unit 12a quantizes each element of x into Q steps to generate q={q₁, q₂, . . . , qₙ}. The image HV generation unit 12a may perform linear quantization or logarithmic quantization.

The image HV generation unit 12a generates a base HV (Lᵢ) represented in expression (4) below. In expression (4), D is the dimension of the HV, for example, 10000. The image HV generation unit 12a randomly generates L₁ and sequentially generates L₂ to L_{Q} by flipping D/Q bits at random positions. Lᵢ and adjacent Li are near to each other, and L₁ and L_{Q} are orthogonal to each other.

L={L₁,L₂, . . . ,L_{Q}},Lᵢ∈{−1,+1}^{D} (4)

The image HV generation unit 12a generates a channel HV (Cᵢ) represented in expression (5) below. The image HV generation unit 12a randomly generates Cᵢ such that all Cᵢ are substantially orthogonal.

C={{C₁,C₂, . . . ,Cₙ},Cᵢ∈−1,+1}^{D} (5)

The image HV generation unit 12a calculates the image HV by using the expression (6) below. In expression (6), “·” is a dot product.

HV=sign(L_{q}_{₁}·C₁+L_{q}_{₂}+ . . . +L_{q}_{ₙ}·Cₙ)∈{−1,+1}^{D} (6)

The sound HV generation unit 12b generates the sound HV based on the feature(s) of the sound. The sound HV generation unit 12b calculates the sound HV by using the base HV and the channel HV in a similar manner to that of the image HV generation unit 12a with the vector of the feature(s) of the sound set as x.

The text HV generation unit 12c generates the text HV based on the feature(s) of the text. The text HV generation unit 12c calculates the text HV by using the base HV and the channel HV in a similar manner to that of the image HV generation unit 12a with the vector of the feature(s) of the text set as x.

The integration unit 13 generates an image attribute section HV by multiplying the image HV and the image attribute HV, generates a semantic attribute space HV by multiplying a semantic HV and a semantic attribute HV, and generates a text attribute section HV by multiplying the text HV and the text attribute HV. The integration unit 13 generates the integrated HV by adding the image attribute section HV, the semantic attribute space HV, and the text attribute section HV. The integration unit 13 passes the integrated HV to the storing unit 14 in the learning phase and to the association unit 16 in the inference phase.

In the learning phase, the storing unit 14 stores the integrated HV generated by the integration unit 13 in the HV memory 15 with the integrated HV related to a label.

The HV memory 15 stores the integrated HV with the integrated HV related to a label. For example, the HV memory 15 stores the integrated HV at an address corresponding to the label. Alternatively, the HV memory 15 relates the label and the integrated HV to each other and stores the label and the integrated HV. The HV memory 15 is a content addressable memory. The speed and density of the HV memory 15 may be increased by using a resistive random-access memory (ReRAM), a memristor, or the like.

In the inference phase, the association unit 16 outputs, as an inference result, a label associated by the HV memory 15 from the integrated HV generated by the integration unit 13. The association unit 16 performs matching between the integrated HV and the HV stored in the HV memory 15 at high speed.

The manipulation unit 17 manipulates the HV memory 15. For example, regarding the knowledge stored in the HV memory 15, the manipulation unit 17 integrates similar pieces of the knowledge and deletes unnecessary pieces of the knowledge. Furthermore, regarding the knowledge stored in the HV memory 15, the manipulation unit 17 moves frequently used pieces of the knowledge together with labels to positions where the knowledge is quickly searched. In the case where a memory having a hierarchical structure is used as the HV memory 15, the manipulation unit 17 discharges pieces of the knowledge having a low usage frequency to a low-speed memory.

The image learning unit 18a updates the image NN 11a. When, for example, the tendency of the image data changes, the image learning unit 18a retrains the image NN 11 a and performs, for example, update of parameters. The sound learning unit 18b updates the sound NN 11b. When, for example, the tendency of the sound data changes, the sound learning unit 18b retrains the sound NN 11b and performs, for example, update of parameters. The text learning unit 18c updates the text NN 11c. When, for example, the tendency of the text data changes, the text learning unit 18c retrains the text NN 11c and performs, for example, update of parameters.

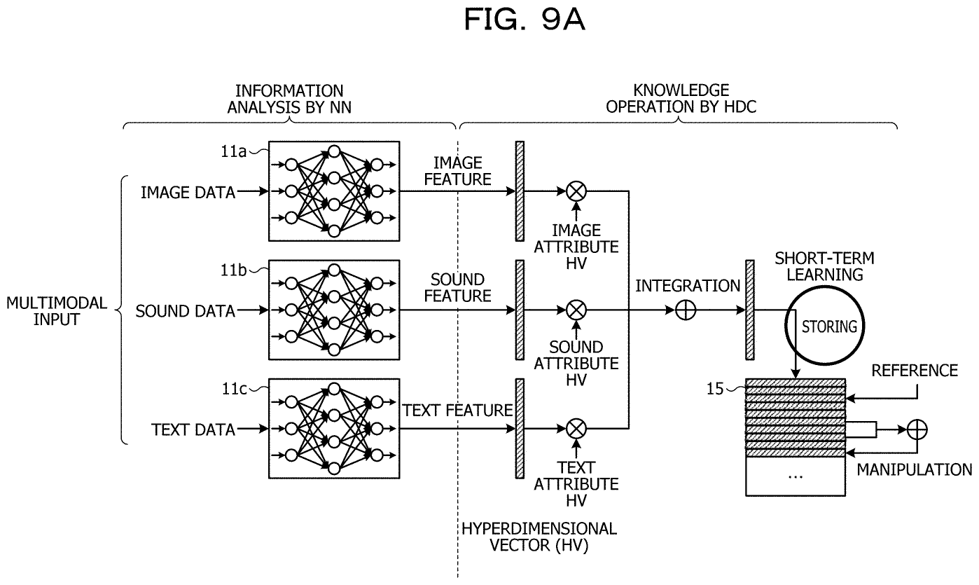

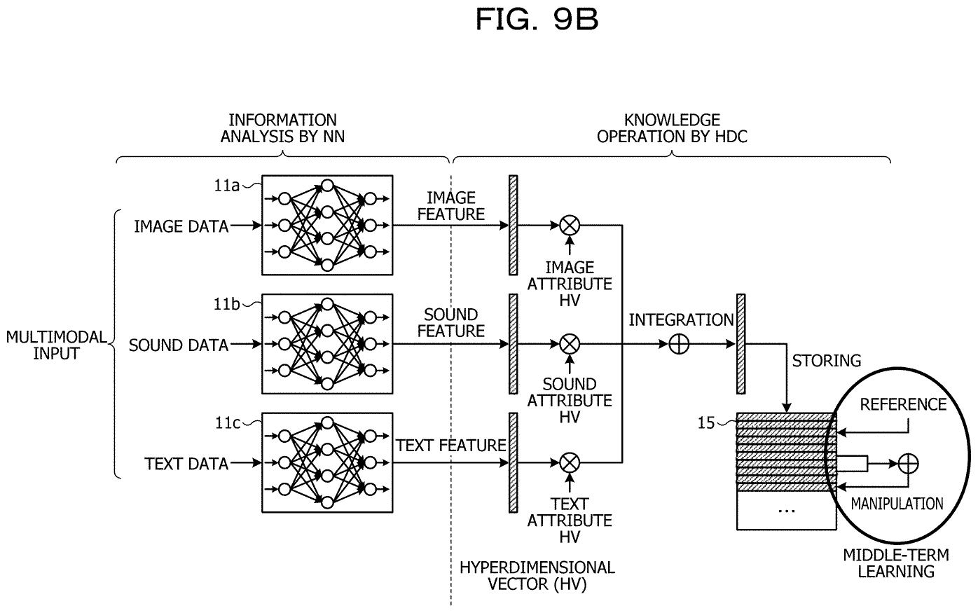

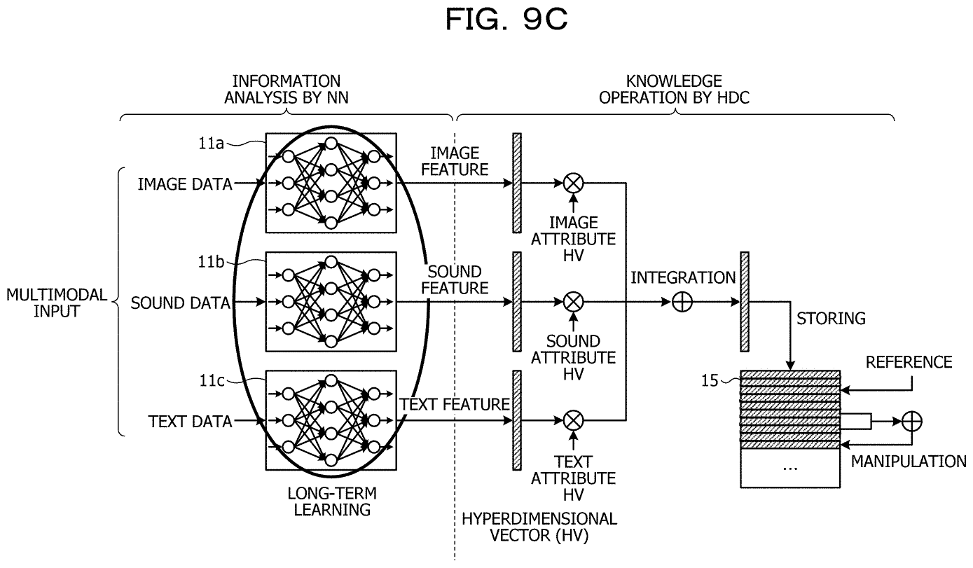

Next, three types of learning performed by the inference apparatus 1 are described with reference to FIGS. 9A to 9C. The inference apparatus 1 has the functions of short-term learning, middle-term learning, and long-term learning. FIG. 9A illustrates short-term learning. The short-term learning is to store the integrated HV in the HV memory 15. The learning phase in the above description corresponds to the short-term learning. Since the short-term learning only performs extraction of the feature(s), simple vector operation, and storing to the HV memory 15, the inference apparatus 1 may perform the short-term learning at high speed.

FIG. 9B illustrates the middle-term learning. In the middle-term learning, the inference apparatus 1 integrates the knowledge and deletes unnecessary HV in order to resolve shortage of the HV memory 15. The manipulation performed by the manipulation unit 17 corresponds to the middle-term learning. The inference apparatus 1 performs middle-term learning while data input is nonoperating.

FIG. 9C illustrates the long-term learning. The image NN 11a, the sound NN 11b, and the text NN 11c for information analysis are trained by using various data presumed in advance. During normal operation, the inference apparatus 1 does not update the parameters of the image NN 11a, the sound NN 11b, or the text NN 11c. However, when, for example, the tendency of the input data changes, the inference apparatus 1 retrains the image NN 11a, the sound NN 11b, and the text NN 11c as the long-term learning. Retraining of the image NN 11a performed by the image learning unit 18a, retraining of the sound NN 11b performed by the sound learning unit 18b, and retraining of the text NN 11c performed by the text learning unit 18c correspond to the long-term learning.

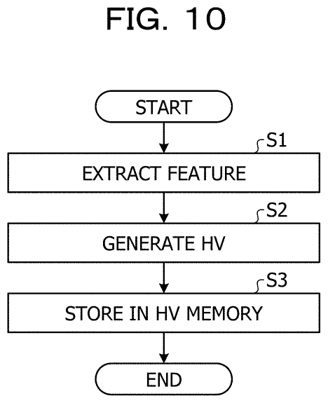

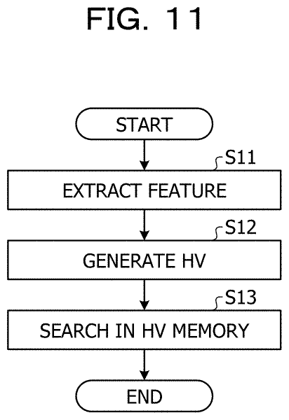

Next, a flow of processing performed by the inference apparatus 1 is described with reference to FIGS. 10 and 11. FIG. 10 is a flowchart illustrating a flow of processing in the learning phase performed by the inference apparatus 1. As illustrated in FIG. 10, the inference apparatus 1 extracts the feature quantities of the training data by using the NNs 11 (step S1). For example, the inference apparatus 1 extracts the image feature(s) by using the image NN 11a, the sound feature(s) by using the sound NN 11b, and the text feature(s) by using the text NN 11c.

The inference apparatus 1 generates the HVs based on the extracted feature quantities (step S2). For example, the inference apparatus 1 generates the image HV based on the image feature(s), generates the sound HV based on the sound feature(s), generates the text HV based on the text feature(s), and generates the integrated HV based on the image HV, the sound HV, and the text HV.

The inference apparatus 1 stores the generated HV in the HV memory 15 with the generated HV related to the label of the training data (step S3).

As described above, the inference apparatus 1 is able to store the knowledge by generating the HV based on the feature quantities of the training data and stores the generated HV in the HV memory 15.

FIG. 11 is a flowchart illustrating a flow of processing in the inference phase performed by the inference apparatus 1. As illustrated in FIG. 11, the inference apparatus 1 extracts the feature quantities of the unknown data by using the NNs 11 (step S11). For example, the inference apparatus 1 extracts the image feature(s) by using the image NN 11a, the sound feature(s) by using the sound NN 11b, and the text feature(s) by using the text NN 11c.

The inference apparatus 1 generates the HVs based on the extracted feature quantities (step S12). For example, the inference apparatus 1 generates the image HV based on the image feature(s), generates the sound HV based on the sound feature(s), generates the text HV based on the text feature(s), and generates the integrated HV based on the image HV, the sound HV, and the text HV.

The inference apparatus 1 searches in the HV memory 15 by using the generated HV (step S13) and identifies a label associated from the generated HV.

As described above, the inference apparatus 1 is able to identify the label of the unknown data by generating the HV based on the feature quantities of the unknown data and searches in the HV memory 15 by using the generated HV.

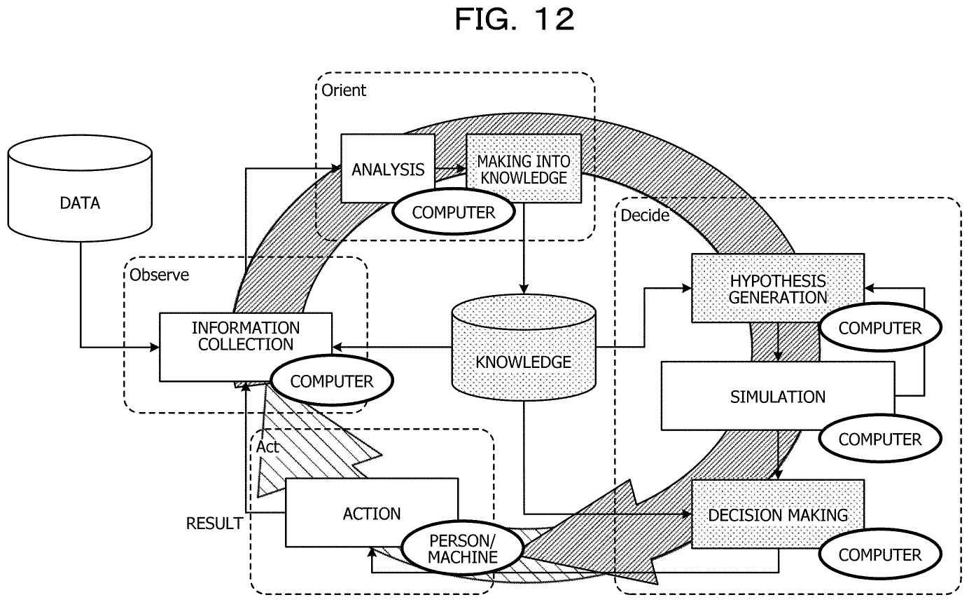

Next, roles of the knowledge in intelligent computing will be described. FIG. 12 illustrates an observe-orient-decide-act (OODA) loop for realizing the intelligent computing. The OODA is a theory related to decision making and action. The OODA loop includes an observe phase, an orient phase, a decide phase, and an act phase. In the observe phase, information is collected. In the orient phase, the collected information is analyzed and made into knowledge. In the decide phase, a hypothesis is generated based on the knowledge, repeating the hypothesis generation performed by simulation, and then making a decision based on the knowledge. In the act phase, action is taken based on the decision making. Information is collected again for the result of the action, and the OODA loop is repeated.

Intelligent computing is realized by causing a computer to make the knowledge based on the analysis, store the knowledge, generate the hypothesis based on the knowledge, and make decision. Thus, generation, storing, and use of the knowledge play an important role in realizing the intelligent computing.

As described above, according to the embodiment, the inference apparatus 1 extracts the feature quantities of the training data by using the NNs 11. The inference apparatus 1 generates the HV of the training data based on the extracted feature quantities. The inference apparatus 1 stores the generated HV in the HV memory 15 as the knowledge with the generated HV related to the label of the training data. Thus, the inference apparatus 1 may clarify and store the knowledge obtained by the NNs 11.

Also according to the embodiment, the inference apparatus 1 extracts the feature quantities of the unknown data by using the NNs 11. The inference apparatus 1 generates the HV of the unknown data based on the extracted feature quantities. The inference apparatus 1 searches in the HV memory 15 by using the generated HV and identifies the label of the unknown data. Thus, the inference apparatus 1 may identify the label of the unknown data at high speed.

According to the embodiment, the image feature(s) is extracted by receiving the image data with the image NN 11a, the sound feature(s) is extracted by receiving the sound data with the sound NN 11b, and the text feature(s) is extracted by receiving the text data with the text NN 11c. The image HV generation unit 12a generates the image HV based on the image feature(s), the sound HV generation unit 12b generates the sound HV based on the sound feature(s), and the text HV generation unit 12c generates the text HV based on the text feature(s). The integration unit 13 generates the integrated HV based on the image HV, the sound HV, and the text HV. Thus, the inference apparatus 1 may perform inference based on multimodal data.

According to the embodiment, the integration unit 13 multiplies the image HV and the image attribute HV, the sound HV and the sound attribute HV, and the text HV and the text attribute HV. Three multiplication results are added to generate the integrated HV. Thus, the inference apparatus 1 is able to separate the individual HVs before integration from the other HVs in the integrated HV.

According to the embodiment, regarding the knowledge stored in the HV memory 15, the manipulation unit 17 integrates similar pieces of the knowledge and deletes unnecessary pieces of the knowledge. Thus, the inference apparatus 1 may improve the knowledge stored in the HV memory 15. Furthermore, regarding the knowledge stored in the HV memory 15, the manipulation unit 17 moves frequently used pieces of the knowledge together with labels to positions where the knowledge is searched early. Thus, the inference apparatus 1 may increase the speed of the inference.

Although the inference apparatus 1 has been described according to the embodiment, an inference program having similar functions may be obtained by realizing the configuration of the inference apparatus 1 with software. A computer that executes the inference program will be described.

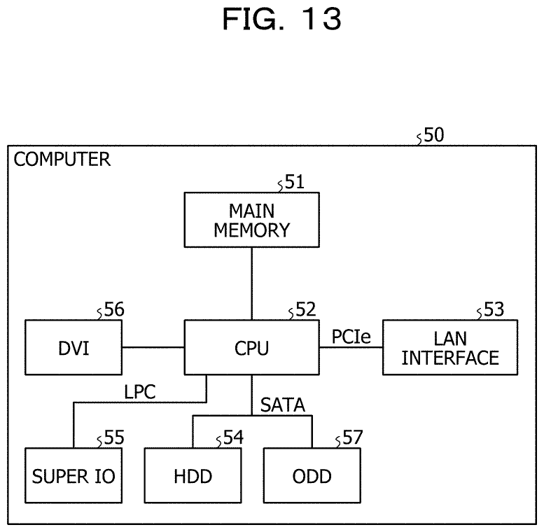

FIG. 13 illustrates a hardware configuration of the computer that executes the inference program according to the embodiment. As illustrated in FIG. 13, a computer 50 includes a main memory 51, a central processing unit (CPU) 52, a local area network (LAN) interface 53, and a hard disk drive (HDD) 54. The computer 50 also includes a super input/output (IO) 55, a digital visual interface (DVI) 56, and an optical disk drive (ODD) 57.

The main memory 51 is a memory that stores programs, intermediate execution results of the programs, and the like. The CPU 52 is a central processing unit that reads the programs from the main memory 51 and executes the programs. The CPU 52 includes a chipset that includes a memory controller.

The LAN interface 53 is an interface for coupling the computer 50 to another computer via a LAN. The HDD 54 is a disk device that stores programs and data, and the super IO 55 is an interface for coupling input devices such as a mouse and a keyboard. The DVI 56 is an interface for coupling a liquid crystal display device, and the ODD 57 is a device for reading from or writing to a Digital Versatile Disc (DVD).

The LAN interface 53 is coupled to the CPU 52 by a Peripheral Component Interconnect Express (PCIe). The HDD 54 and the ODD 57 are coupled to the CPU 52 by a Serial Advanced Technology Attachment (SATA). The super IO 55 is coupled to the CPU 52 by a low pin count (LPC).

The inference program to be executed by the computer 50 is stored in the DVD as an example of a recording medium readable by the computer 50, read from the DVD by the ODD 57, and installed in the computer 50. Alternatively, the inference program is stored in a database or the like of another computer system coupled through the LAN interface 53, read from the database or the like, and installed in the computer 50. The installed inference program is stored in the HDD 54, loaded to the main memory 51, and executed by the CPU 52.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an inference program for causing a computer to execute a process, the process comprising:
extracting features of a piece of data by inputting the piece of data to a neural network;
generating a hyperdimensional vector based on the extracted features; and
storing the generated hyperdimensional vector in a storage unit with the hyperdimensional vector related to a label of the piece of data.

2. The non-transitory computer-readable recording medium according to claim 1, wherein,
regarding a plurality of the pieces of data, the storage unit stores with the hyperdimensional vector and the label related to each other, and wherein
the process further includes
extracting features of a piece of unknown data by inputting the piece of unknown data to the neural network,
generating a hyperdimensional vector of the piece of unknown data based on the features extracted from the piece of unknown data, and
referring to the storage unit by using the hyperdimensional vector generated from the piece of unknown data and identifying a label of the piece of unknown data.

3. The non-transitory computer-readable recording medium according to claim 1, wherein
the piece of data includes a piece of image data, a piece of sound data, and a piece of text data, wherein
the extracting extracts image features by inputting the piece of image data to an image neural network, extracts sound features by inputting the piece of sound data to a sound neural network, and extracts text features by inputting the piece of text data to a text neural network, wherein
the generating generates an image hyperdimensional vector based on the image features, generates a sound hyperdimensional vector based on the sound features, generates a text hyperdimensional vector based on the text features, and generates the hyperdimensional vector based on the image hyperdimensional vector, the sound hyperdimensional vector, and the text hyperdimensional vector.

4. The non-transitory computer-readable recording medium according to claim 3, wherein
the generating generates an image attribute space vector by multiplying the image hyperdimensional vector by an image attribute hyperdimensional vector, generates a sound attribute space vector by multiplying the sound hyperdimensional vector by a sound attribute hyperdimensional vector, generates a text attribute space vector by multiplying the text hyperdimensional vector by a text attribute hyperdimensional vector, and generates the hyperdimensional vector based on the image attribute space vector, the sound attribute space vector, and the text attribute space vector.

5. The non-transitory computer-readable recording medium according to claim 1, the process further comprising:
manipulating including,
manipulating in which the hyperdimensional vector stored in the storage unit and the label are moved, and
manipulating in which a plurality of the hyperdimensional vectors stored in the storage unit are integrated.

6. A computer-implemented method comprising:
extracting features of a piece of data by inputting the piece of data to a neural network;
generating a hyperdimensional vector based on the extracted features; and
storing the generated hyperdimensional vector in a storage unit with the hyperdimensional vector related to a label of the piece of data.
